(19) United States
(12) Patent Application Publication
(10) Pub. No.: US 2012/0108186 A1
(43) Pub. Date: May 3, 2012

(54) TRANSMITTER WITH MULTIPLE TRANSMIT ANTENNAS USING POLARIZATION

(75) Inventors: Bo Göransson, Sollentuna (SE); Sven Petersson, Savedalen (SE); Martin Johansson, Molndal (SE); Fredrik Ovesjö, Alvsjo (SE)

(73) Assignee: TELEFONAKTIEBOLAGET L M ERICSSON (PUBL), Stockholm (SE)

(21) Appl. No.: 13/382,272

(22) PCT Filed: Aug. 31, 2009
(86) PCT No.: PCT/SE2009/050979

§ 371 Date: Jan. 4, 2012

Related U.S. Application Data
(60) Provisional application No. 61/223,868, filed on Jul. 8, 2009.

(51) Int. Cl. H04W 4/00; H04B 7/02

(52) U.S. Cl. 455/101

(57) ABSTRACT

A transmitter for transmitting data in a cellular radio system is provided. The transmitter transmits data to User Equipment(s) using multiple transmitting antennas, using at least two polarization formers generating orthogonal polarizations of an input data stream. The transmitter further comprises a transmitter diversity arrangement adapted to receive input data to be transmitted to the User Equipment(s), where the transmitter diversity arrangement is connected to the input terminals of the polarization formers. By combining transmitter diversity with polarization former weights, orthogonality between multiple, in particular 4, transmitting antennas can be obtained.

### TECHNICAL FIELD

The present invention relates to a method and an apparatus for transmitting data via multiple transmitting antennas.

### BACKGROUND

Increasing the number of transmitting antennas is one way of increasing the capacity and coverage in a wireless radio system. For example, in Long Term Evolution (LTE) radio system different transmit schemes for up to 4 transmit antennas have been standardized. The increased number of antennas can be used to increase diversity, e.g. by using different kinds of transmission diversity schemes, or to increase the data rate by means of spatial multiplexing using Multiple Input Multiple Output, MIMO.

Since all LTE User Equipments (UE) support the use of 4 transmit antennas in the evolved NodeB (eNB), evolutions in the network is secured. In a first deployment, only a single or maybe 2 transmit antennas might be deployed on the network side. When the load is increasing the networks can be upgraded to 4 Transmit antennas, and all legacy LTE UEs will support e.g. channel estimation for all 4 transmit antennas. In this way, it can be made sure that the investment in additional transmit antennas, including power amplifier, more cabling etc is well utilized in the network since all users will benefit.

For Wideband Code Division Multiple Access/High Speed Packet Access (WCDMA/HSPA) the situation is somewhat different. In Release 99 (R'99) all UEs are required to support up to 2 transmit antennas in the NodeB enabling demodulation of two pilot channels. In most cases, only one antenna is deployed in the network, but transmission diversity with two transmitting antennas may also be deployed. In Release 7 (Rel-7), dual-layer MIMO was introduced in High Speed Downlink Packet Access (HSDPA) and hence two antennas have to be used both in the NodeB and the UE in order to support MIMO.

The corresponding problem of deploying 2 transmit antennas, e.g. to support 2×2 MIMO in HSDPA, but still utilizing all available power for legacy users expecting single antenna transmission can be implemented by using a combination of different orthogonal polarization formers, as described in the international application No. WO 2006/071153.

When upgrading to more transmitting antennas at the network node, one important issue is to make efficient use of the power amplifier (PA) resource. One common way to deploy the network node is to have one PA per antenna port as shown in FIG. 1.

In a scenario where two transmit antennas are deployed at a WCDMA/HSPA base station, e.g. to support dual-stream MIMO, two additional power amplifiers will be added to the configuration in FIG. 1, when upgrading this network node to support e.g. 4×4 MIMO. This will increase the total available power by a factor of 2 compared to the case with 2 transmitting antennas. This additional power will however not be available to legacy users since they only support demodulation from 2 transmit antennas.

As a result of the above the benefit for an operator investing in more transmit antennas (including power amplifier resources) will be limited in this scenario. In other words, as long as a large part of the UE population only can receive data from 2 transmit antennas, the network has to be planned according to them, and hence no coverage gain is obtained if additional transmit antennas are introduced, since the legacy UEs can not benefit from the additional power/antennas deployed.

One way to overcome this problem would be to use a pre-coder or weight vector that distributes the signal over the total PA resource as shown in FIG. 2.

The problem with such a solution is that coverage may be difficult to maintain. If the antennas are assumed uncorrelated or at least almost uncorrelated the resulting beam pattern may look as in FIG. 3a. On the other hand, if the antennas are highly correlated (a coherent array) the resulting free-space beam pattern may look as in FIG. 3b. Assuming a 120° sector, it is seen that neither beam pattern would suffice for good coverage. Note that the beam patterns showed in the figures do not contain the effect from the radio channel and the resulting beam pattern would depend on the instantaneous radio channel. In fact, it is not the antennas themselves which are correlated or uncorrelated but rather the signals transmitted from or received at the antennas. In general, closely spaced antennas would generate signals with high correlation while signals transmitted from widely spaced antennas tend to be less correlated. However the exact level of correlation will depend on radio channel properties such as dispersion and angular spread. Similarly, signals transmitted (or received) from antennas with two orthogonal polarizations tend to have very low correlation.

Hence, there exist a need for a method and a device that would reduce or eliminate the problems associated with existing solutions and where all installed power can be utilized also by legacy User Equipment not supporting reception of data from multiple transmit antennas.

### SUMMARY

It is an object of the present invention to provide an improved method and apparatus for transmitting signals in a radio system using multiple transmission antennas. In particular it is an object of the present invention to reduce or eliminate the problems as described above.

This object and others are obtained by the method and device as set out in the appended claims. Thus, a transmitter for transmitting data in a cellular radio system is provided. The transmitter transmits data to User Equipment(s) using multiple transmitting antennas, using at least two polarization formers enabling transmission of orthogonally polarized signals of an input data stream. The transmitter further comprises a transmitter diversity arrangement adapted to receive input data to be transmitted to the User Equipment(s), where the transmitter diversity arrangement is connected to the input terminals of the polarization formers. By combining transmitter diversity with polarization former weights, orthogonality between multiple transmitting antennas can be obtained. In accordance with one embodiment 4 transmitting antennas are supported.

In accordance with one embodiment a transmitter for transmitting data in a cellular radio system is provided. The transmitter comprises multiple transmitting antennas to transmit data to User Equipment(s) using multiple transmitting antennas. The transmitter further comprises at least two polarization formers enabling transmission of orthogonally polarized signals of an input data stream and a transmitter diversity arrangement adapted to receive input data to be transmitted to the User Equipment(s), where the transmitter diversity arrangement is connected to the input terminals of the polarization formers. Hereby data to legacy terminals supporting only 2-antenna downlink transmit diversity can utilize the total installed power sent from multiple, in particular 4 antennas. Another benefit is that this can be achieved with no or low requirements on coherency at the transmitter. Achieving good coherency is, in general, expensive and requires calibration network and such. Another advantage of such a transmitter is that High Speed Downlink Packet Access (HSDPA) easily can be extended to support e.g. 4×4 MIMO, which can double the supported peak-rate, while still supporting legacy terminals in an efficient way.

In accordance with one embodiment the transmitter comprises a selector for selecting which data to direct to the transmitter diversity arrangement and which data to be directed directly to the polarization formers. The selector can be adapted to select data to be transmitted to a User Equipment not supporting transmission from multiple transmit antennas, to be directed to the transmitter diversity arrangement. In particular the selector can be adapted to select data to be transmitted to a User Equipment not supporting MIMO transmission to be directed to the transmitter diversity arrangement.

In accordance with one embodiment the transmitter diversity arrangement is a Space-Time Transmit Diversity (STTD) arrangement.

The invention also extends to a method for transmitting data using a transmitter as described above.

### BRIEF DESCRIPTION OF THE DRAWINGS

The present invention will now be described in more detail by way of non-limiting examples and with reference to the accompanying drawings, in which:

FIG. 1 is a view of a transmitter arrangement with multiple transmit antennas,

FIG. 2 is a view of a transmitter arrangement with multiple transmit antennas comprising a pre-coder,

FIGS. 3a and 3b are views illustrating different beam patterns,

FIG. 4 is a view illustrating a cellular radio system,

FIG. 5 is a view of a transmitter with multiple transmit antennas in accordance with one embodiment,

FIG. 6 is a view of a transmitter with multiple transmit antennas in accordance with another embodiment, and

FIG. 7 is a flowchart illustrating steps performed when transmitting data using a transmitter having multiple transmit antennas.

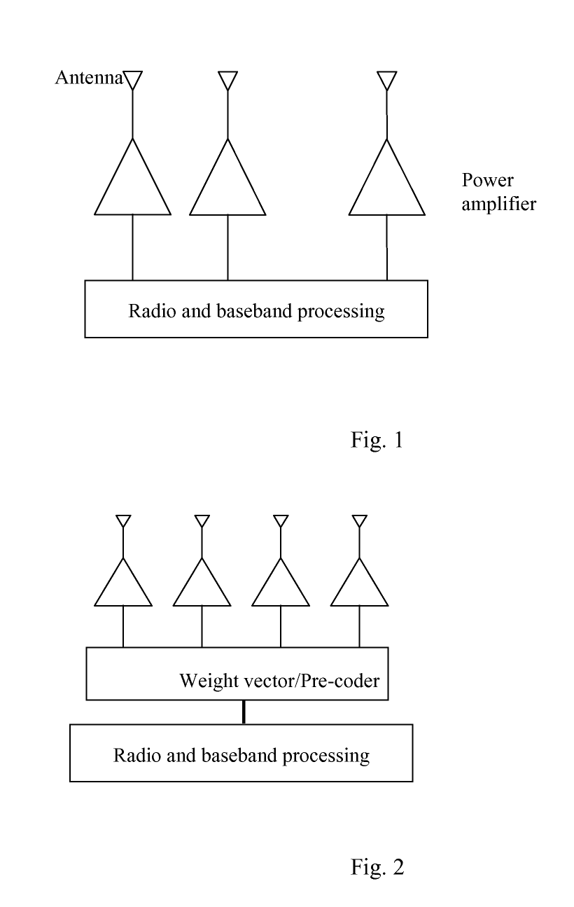

### DETAILED DESCRIPTION

In FIG. 4 a view schematically illustrating a cellular radio system 100 is shown. The system comprises a number of radio base stations here denoted Node B 101. The NodeBs 101 can in turn be connected to a central node of the cellular radio system such as a Radio Network Controller (RNC) 105. The base stations 101 are further connectable to User Equipments 103 of the radio system 100 over a radio interface, thereby providing access to the cellular radio system for a User Equipment located within an area covered by the cellular radio system.

The NodeB is provided with a transmitter 109 having multiple transmit antennas enabling MIMO transmission over the air interface. In order to provide good performance for UEs not configured for MIMO, the transmitter 109 is adapted to using a transmitter diversity transmission scheme such as STTD in combination with an orthogonal polarization of the transmitted signal. In addition the NodeB can be provided with a selector 108. The selector 108 can be configured to select data input for transmission. The selector can also be integrated with the transmitter 109.

Since power is one of the limiting factors in downlink, utilizing this scarce resource is very important. When upgrading systems with additional transmit antennas, additional power will be added. For example when upgrading from 2 transmitting antennas to 4 transmitting antennas, another 3 dB of output power will become available. The problem in many wireless standards is that existing (legacy) terminals will not be made aware of the additional antennas, and hence the extra power resource will only be available to new User Equipments, which are aware of the extra antennas. This can lead to coverage problems for legacy terminals. If the network is planned for e.g. 4×20 W output power, legacy terminals can only utilize 2×20 W.

In accordance with one embodiment combinations of spatially separated arrays and different orthogonal polarizations are used to create load balancing between all deployed antennas and power amplifiers when a wireless system is migrated to a system using an increased number of transmitting antennas, e.g. from 2 transmitting antennas to 4 transmitting antennas.

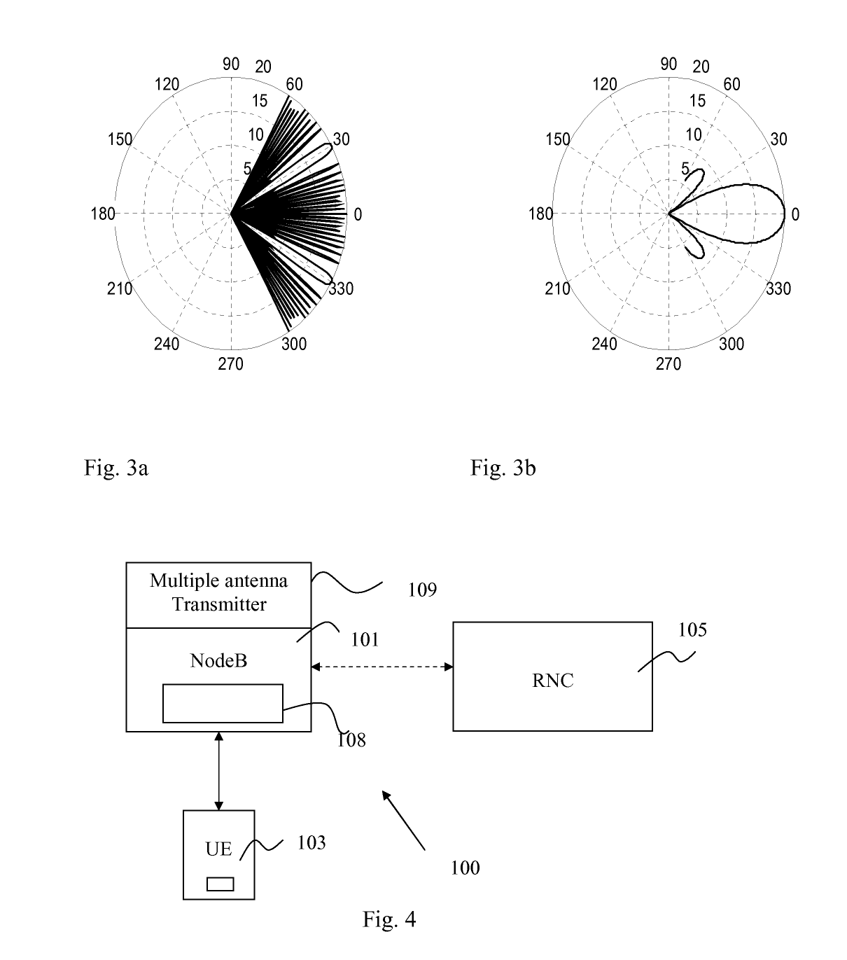

One problem that may occur when transmitting from several spatially separated antennas is that a beamforming effect can appear. If the same signal is transmitted from e.g. two antennas with high fading correlation a beam is formed, see FIG. 3b. In some systems this can be used to improve system performance, since the effective antenna gain is increased 3 dB per pair of antenna elements. This gain however is directional, meaning that in some other direction (outside the main beam) the antenna gain is dropped considerably. As a result the cell coverage can not be maintained, which will cause a serious problem in a cellular system. One way to avoid this beamforming effect is to transmit different signals from the different antennas. This can be achieved by using some kind of scrambling where a scrambling sequence is applied to the data before transmission. If the scrambling sequences are different for different antennas, the beamforming effect can be avoided. Alternatively, the transmitted symbols can be swapped in time. For example, the sequence S1, S2, S3, S4 is transmitted from one antenna while S2, S1, S4, S3 is transmitted from a second antenna. In this case it is seen that in every symbol time, different symbols are transmitted from the two antennas, hence beamforming is avoided.

In the case of Wideband Code Division Multiple Access/High Speed Downlink Packet Access (WCDMA/HSDPA) it is also possible to utilize transmit diversity options, e.g. Space-Time Transmit Diversity (STTD), available in the standard.

By combining a combination of different orthogonal polarizations and a transmitter diversity option an improved method and apparatus for transmitting signals using more than 2 transmitting antennas can be obtained. In particular the transmitter diversity can be STTD—Space-Time Transmit Diversity available in WCDMA/HSDPA. Also, similar transmit diversity options are also available in other wireless communications systems, for example, CDMA2000 contains Space-Time Spreading (STS) and Orthogonal Transmit Diversity (OTD) and can be used in a corresponding manner in such radio systems.

By using STTD in the network, both legacy, non-MIMO enabled, R'99 terminals as well as

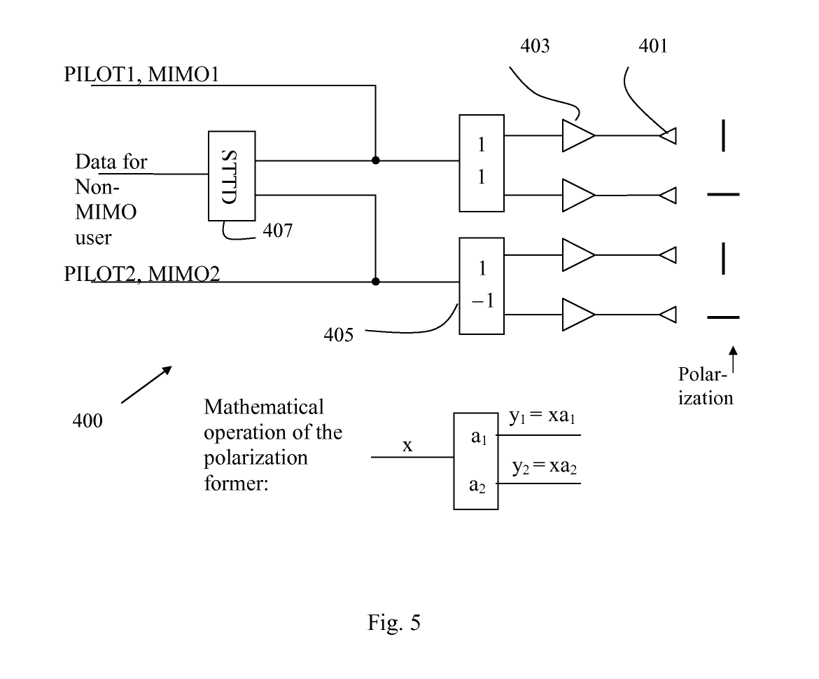

MIMO capable Rel-7 terminals will support 2 transmitting antennas at the network side. Introducing 4 transmitting antennas can be performed by using STTD for legacy channels and distribute each output from the STTD encoder to a polarization former as shown in the transmitter 400 in FIG. 5. Thus data transmitted to a User Equipment not supporting reception of data transmitted from multiple transmitting antennas, in particular data to be transmitted to a User Equipment not supporting MIMO transmission, is fed to a transmitter diversity arrangement, such as STTD. This step can be performed by the selector 108 in FIG. 4, which can be integrated in the transmitter 400. In another embodiment the transmitter is connected to the selector 108.

In FIG. 5 an exemplary embodiment of a transmitter 400 illustrating how 4 transmit antennas 401 associated with one power amplifier 403 each can be used to support 2×2 Multiple Input Multiple Output MIMO and legacy data directed to non-MIMO enabled users with STTD encoding. Note that all signals or channels associated with a certain pilot signal PILOT are processed in the same way to be detectable by the users. In the transmitter depicted in FIG. 5 a transmitter diversity arrangement 407 such as STTD is adapted to receive data to be transmitted to a legacy UE. The output terminals from the transmitter diversity arrangement are connected to input terminals of polarization formers 405. The output terminals of the polarization formers are connected to a respective antenna 401 associated with a corresponding power amplifier 403. Data for UEs supporting multiple transmitting antennas such as MIMO enabled UEs, in this case 4 transmitting antennas are fed directly the two polarization formers 405. The different MIMO data streams are associated with the different PILOT signals as is shown in FIG. 5. For example MIMO data stream 1 is associated with PILOT signal 1, etc. In the FIG. 5, vertical and horizontal polarizations are assumed to be transmitted from the antennas, but any type of orthogonal polarization can be used.

The polarization formers 405 used in FIG. 5 result in orthogonally polarized signals being transmitted from the respective antennas. Further, it is assumed that all antenna elements are identical except the polarization and have the same spatial pointing direction. Also, in FIG. 5 polarization forming weights [1 1] and [1 −1] are used. However, any orthogonal weights can be used. If ±45° slanted polarization is used at the transmit antennas using the weights [1 j] and [1 −j], will result in circular polarization (left and right) of the transmitted wave.

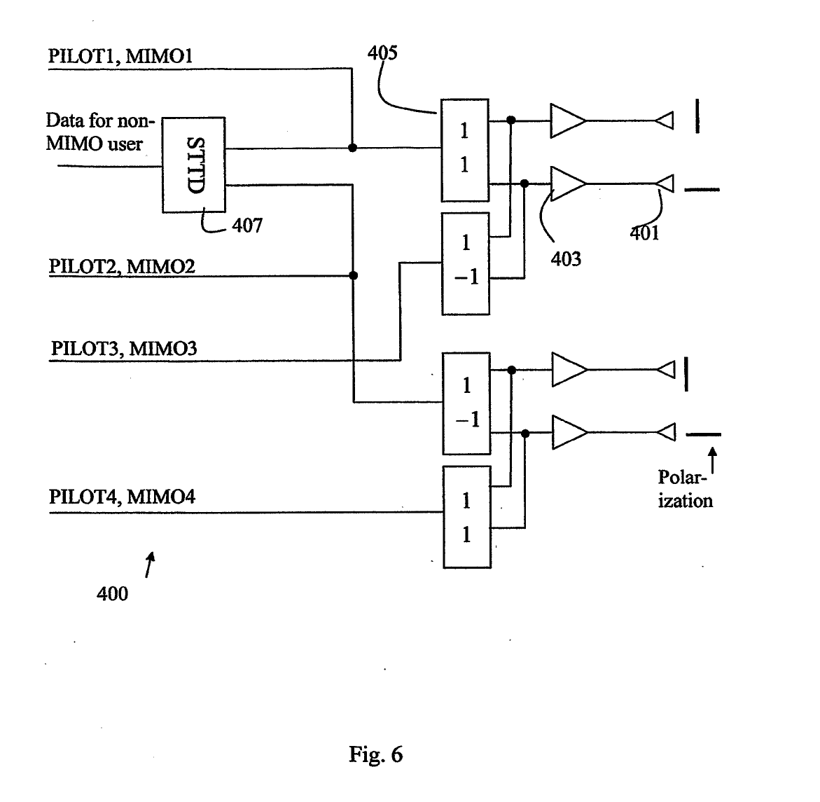

The method and apparatus as described herein can further be expanded to support a future 4 transmit antenna mode, e.g. 4×2 or 4×4 MIMO, by inserting additional polarization forming elements as exemplified in FIG. 6. In FIG. 6 one exemplary embodiment illustrating one contemplated expansion of the implementation in FIG. 5 is shown. The example in FIG. 6 shows how to support transmission of data to legacy User Equipment using STTD, 2×2

MIMO and 4×Y MIMO using 4 transmitting antennas. The transmitter in FIG. 6 comprises four input MIMO channels each connected to a respective polarization former and a transmitter diversity arrangement adapted to receive data to a legacy, non-MIMO enabled, receiver. The exact mapping of signals to virtual antennas can be different and also the weights used in this example could be replaced by any other orthogonal weight pairs.

The polarization forming, and combining of signals, of the transmitter shown in FIG. 6 can be performed on baseband with perfect coherency. Looking at one pair of antennas (top or bottom) there is no coherency required for the radio chains since the two inherent polarizations will, depending on phase relation, combine to any two elliptical, but still orthogonal, polarizations (all equally good). The same conclusion holds also for the other pair of antennas. To fully exploit performance for 4 MIMO streams coherency may however be required dependent on transmission scheme and antenna configuration. For example, performance for a scheme according to Long Term Evolution (LTE) in combination with a quad-antenna is dependent on coherency.

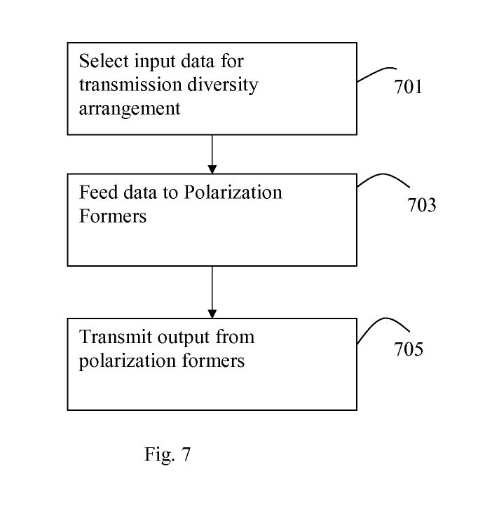

In FIG. 7, a flowchart illustrating some steps performed when transmitting data to a UE using the apparatus as described above is shown. First in a step 701 data to be transmitted to a legacy, non-MIMO enabled, UE not supporting reception of data transmitted using multiple antennas, in particular data transmitted using at least 4 transmitting antennas are selected and fed to a transmitter diversity arrangement. The output from the transmitter diversity arrangement and data not selected in step 701 is then fed to polarization formers generating two output signals orthogonal to each other in a step 703. The output signals from the polarization formers are then in a step 705 transmitted orthogonally polarized using multiple transmit antennas, in particular using one transmit antenna for each output signal from the polarization formers.

It should further be noted that the 4 transmit antenna case depicted in FIG. 6 is just one example. This concept can easily be extended to any suitable number of transmit antennas. For example, in LTE all terminals support reception from 4 transmit antennas at the network node. Extension to 8 transmit antennas in a future system can be implemented with a straightforward extension of FIG. 6. For example a legacy 4 transmit transmission can be fed through the polarization formers, whereas 8 transmit data can be fed directly to the 8 antennas through respective power amplifier.

Using the method and apparatus as described herein will provide full utilization for an increased number of transmitters, also for systems having legacy terminals supporting demodulation from a single or two antennas. In particular if 4 transmitting antennas used, the method an apparatus as described herein will be significantly better than existing solutions.

1. A transmitter for transmitting data in a cellular radio system, wherein data are transmitted to User Equipment(s) using multiple transmitting antennas, the transmitter comprising:
at least two polarization formers adapted for transmission of orthogonally polarized signals of an input data stream; and
a transmitter diversity arrangement adapted to receive input data to be transmitted to the User Equipment(s), the transmitter diversity arrangement further being connected to the input terminals of the polarization formers.

2. The transmitter according to claim 1, further comprising a selector for selecting which data is directed to the transmitter diversity arrangement and which data is directed directly to the polarization formers.

3. The transmitter according to claim 2, wherein the selector is adapted to select data to be transmitted to a User Equipment not supporting Multiple Input Multiple Output, MIMO, transmission to be directed to the transmitter diversity arrangement.

4. The transmitter according to claim 1, wherein the transmitter arrangement is adapted to transmit with Space-Time Transmit Diversity.

5. The transmitter according to claim 1, wherein the transmitter comprises 4 transmitting antennas used to transmit to the User Equipment(s).

6. A method of transmitting data in a cellular radio system, wherein data are transmitted to User Equipment(s) using multiple transmitting antennas, wherein data is fed to at least two polarization formers enabling transmission of orthogonally polarized signals of an input data stream, the method comprising:
transmitting data via a transmitter diversity arrangement receiving input data to be transmitted to the User Equipment(s), and subsequently via the polarization formers.

7. The method according to claim 6, further comprising selecting which data is directed to the transmitter diversity arrangement and which data to is directed directly to the polarization formers.

8. The method according to claim 6, wherein data to be transmitted to a User Equipment not supporting Multiple Input Multiple Output, MIMO, transmission is selected to be transmitted by the transmitter diversity arrangement.

9. The method according to claim 6, further comprising operating the transmitter arrangement to transmit with Space-Time Transmit Diversity.

10. The method according to claim 6, wherein the output signals from the polarization formers are transmitted using 4 transmitting antennas.

11. The transmitter according to claim 3, wherein the transmitter arrangement is adapted to transmit with Space-Time Transmit Diversity.

12. The transmitter according to claim 11, wherein the transmitter comprises 4 transmitting antennas used to transmit to the User Equipment(s).
